(19) United States
(12) Patent Application Publication
(10) Pub. No.: US 2014/0305729 A1
(43) Pub. Date: Oct. 16, 2014

(54) ELECTRIC MOTORCYCLE

(71) Applicant: CRP SERVICE S.R.I., Modena (IT)

(72) Inventors: Giampiero TESTONI, Milano (IT); Livia CEVOLINI, Modena (IT)

(73) Assignee: CRP SERVICE S.r.I., Modena (IT)

(21) Appl. No.: 13/861,461

(22) Filed: Apr. 12, 2013

(51) Int. Cl. B60L 11/18

(52) U.S. Cl. CPC B60L 11/1879
USPC 180/220

(57) ABSTRACT

The electric motorcycle (1) includes: an electric battery; a bearing frame (3) including a headtube (4) for the steering of at least a front wheel (6), from which headtube (4) extend laterally, in a single body piece, two truss-like extensions (7, 8) which elongate rearwardly, so as to substantially define a U-profile, the frame (3) being able to house the battery between the extensions (7, 8); a propulsion unit (31), including an electric motor and a motorcycle transmission, the latter being coupled to the electric motor, the unit (31) being mounted on the frame (3); and a rear fork (30) joined to a rear wheel (32) and mounted oscillating on the frame (3).

### FIELD OF THE INVENTION

The present invention relates to an electric motorcycle.

### BACKGROUND OF THE INVENTION

Motorcycles are known having an electric drive system supplied by rechargeable batteries.

U.S. Pat. No. 8,312,954 describes a motorcycle of this type.

In particular, such motorcycle includes a load-bearing frame configured like a polygonal cage, open on the bottom and on the top, and designed to house a battery assembly inside it.

The perimeter of such cage is composed of the front steering head, of a right and a left structural truss, bolted onto the head, and of a motor block, which encloses the motor and the transmission, in turn bolted onto the trusses.

In practice, the motor block defines the rear wall of the cage frame, and it is the frame component that directly supports the oscillating fork connected to the hub of the rear wheel.

Not only, but the motor, in this known solution, also bears the supply batteries.

This solution is very complex and costly because it requires the manufacture of both a motor block specifically designed to act as part of the frame, and of side trusses specifically designed to be fastened to the motor to define the sides of the frame.

Because of this, furthermore, the front head has to be manufactured separately and then all the frame components have to be bolted onto one another.

The assembly procedure is also therefore rather costly.

Furthermore, because the motor defines one of the sides of the frame, and has a bearing function in relation to the batteries, this places a restraint on the size of the batteries that can be accommodated in the cage.

### SUMMARY OF THE INVENTION

The main aim of the present invention is to provide an electric motorcycle that can be manufactured, assembled and disassembled quickly and inexpensively.

Within this aim, one object of the present invention is to provide an electric motorcycle that can house batteries of different sizes.

Another object of the present invention is to provide an electric motorcycle which allows to overcome the mentioned drawbacks of the state of the art in the ambit of a simple, rational, easy and effective to use as well as low cost solution.

The above objects are reached by the electric motorcycle of the invention comprising:
at least an electric battery;
at least a bearing frame comprising a headtube for the steering of at least a front wheel, from which headtube extend laterally, in a single body piece, two truss-like extensions which elongate rearwardly, so as to substantially define a U-profile, said frame being able to house said battery between said extensions;
at least a propulsion unit, comprising an electric motor and a motorcycle transmission, the latter being coupled to said electric motor, said unit being mounted on said frame; and
at least a rear fork joined to a rear wheel and mounted oscillating on said frame.

### BRIEF DESCRIPTION OF THE DRAWINGS

Other characteristics and advantages of the present invention will become more evident from the description of a preferred, but not sole, embodiment of an electric motorcycle, illustrated purely as an example but not limited to the annexed drawings in which:

FIG. 1 is a side view of the motorcycle according to the invention;

FIG. 2 is a top view of the frame of the motorcycle according to the invention;

FIG. 3 is an exploded view of the frame, of the drive assembly and of the casing of the battery of the motorcycle according to the invention; and

FIG. 4 is an exploded view of the frame and of the shock-absorbing unit of the motorcycle according to the invention.

### DETAILED DESCRIPTION OF THE INVENTION

With particular reference to such figures, globally indicated by 1 is the electric motorcycle according to the invention.

Because the motorcycle 1 is of the electric type, its operation requires a source of electricity in the form of one or more batteries.

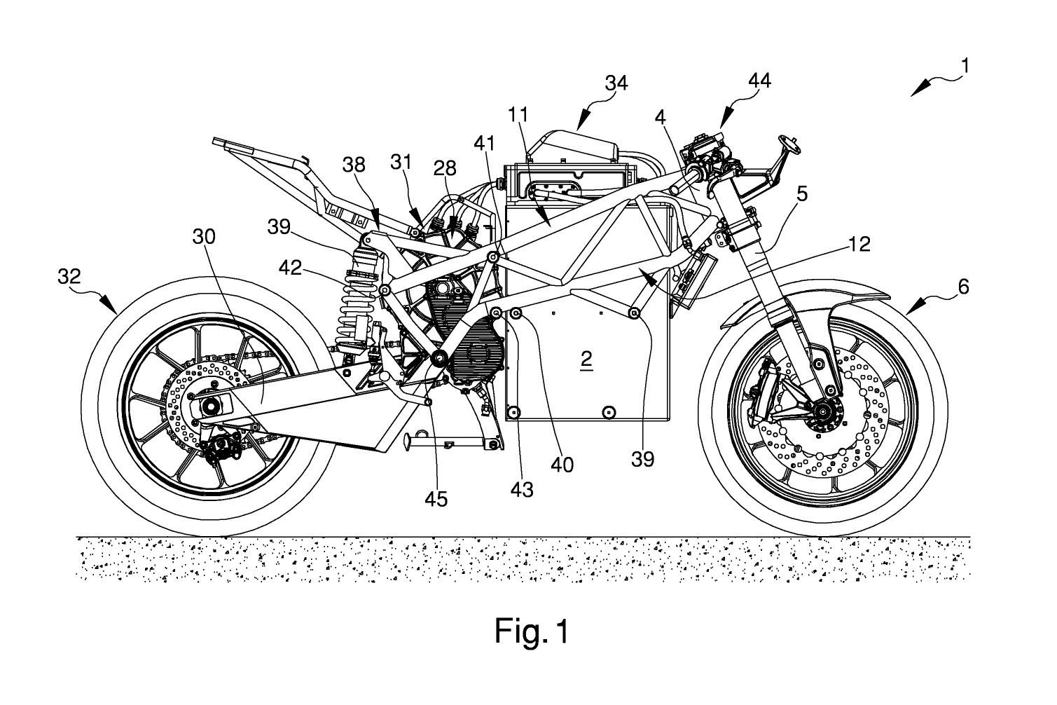

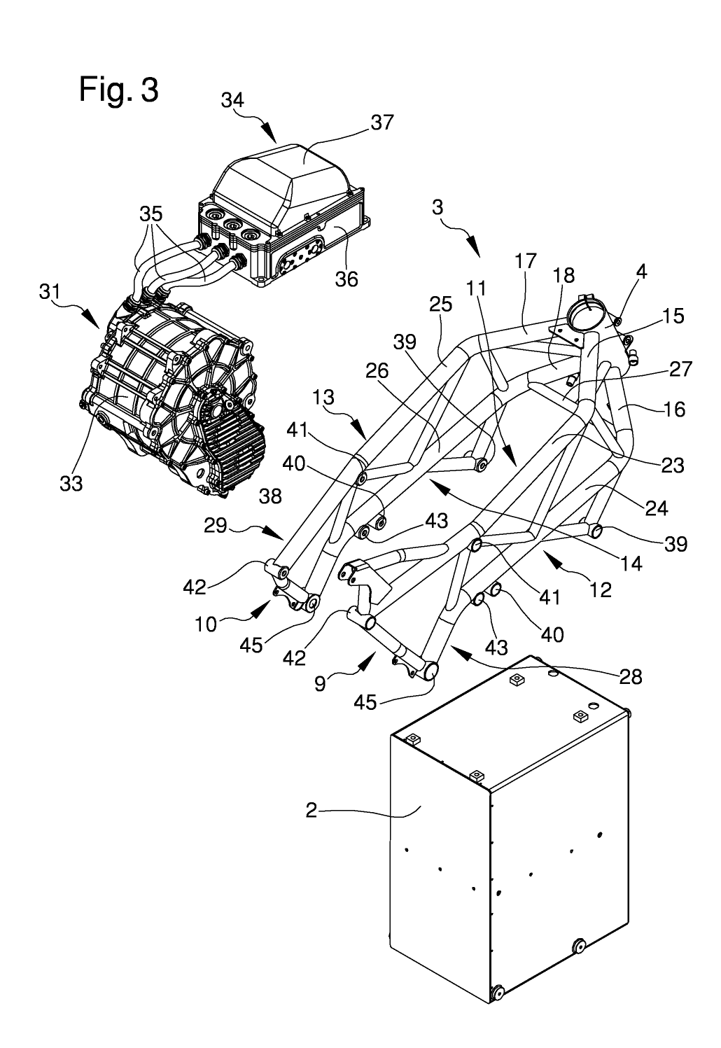

In particular, as can be seen in the FIGS. 1 and 3, the invention envisages a box casing 2, substantially closed, with prismatic shape, e.g., parallelepiped, containing the battery cells.

As will be made clear in a subsequent paragraph, such casing 2 provides further functions besides containing, protecting and transporting the battery.

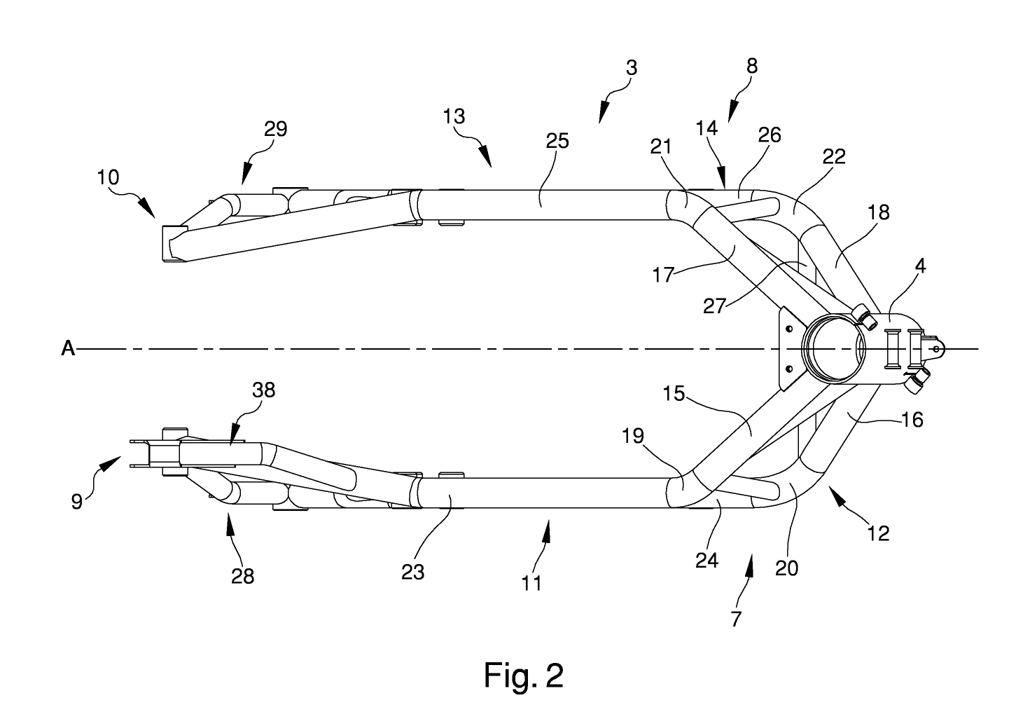

The proposed motorcycle 1 includes a load-bearing frame 3, shown in all the illustrations, but clearly visible above all in the FIGS. 2-4.

The frame 3 of the invention is a truss-like frame and is made of one piece, i.e., its parts are either made in an integral block or are permanently joined by welded joints, or both things together.

Consequently, the different parts of the frame 3 are not connected by bolts or similar releasable fastening means.

The frame 3 first of all comprises a headtube 4, arranged at the front of the motorcycle 1, along the longitudinal axis A of same, and therefore in central position.

The tube 4 can be coupled in a known way to the front fork 5, to which is fastened the front wheel 6, this too placed centrally to the motorcycle 1.

From the tube 4 extend laterally two truss-like extensions 7, 8 which elongate at the rear, towards the back of the motorcycle 1, to substantially define a U-profile of the frame 3, as FIG. 2 clearly shows.

To be precise, the two extensions 7, 8, start from the tube 4 and continue separate from one another and end at the extremities 9, 10, separated from one another, to identify a frame 3 which, if seen from above or below, has a generically U-shaped contour.

In other words, the perimeter of the frame 3 considered alone is an open perimeter.

The extremities 9, 10 are separated in the sense that, before the frame 3 is fitted in the motorcycle 1, they are free extremities, as shown in the FIGS. 2-4.

Clearly, once the frame 3 has been fitted on the motorcycle 1, the extremities 9, 10 of the extensions 7, 8 are connected transversally by other components of the motorcycle 1.

Consequently, in practice, the frame 3 makes up a support and containment structure open both at the rear and at its bottom and at its top.

According to one preferred structural aspect, clearly visible in FIG. 2, the frame 3 is substantially symmetric with respect to a plane that passes through the longitudinal axis A of the motorcycle 1.

When the motorcycle 1 is perfectly “stood up”, i.e., at right angles to the ground, such plane is vertical.

Always preferably, as the attached illustrations clearly show, the truss-like extensions 7, 8 each comprise two main branches 11, 12, 13, 14, e.g. made up of a solid or internally hollow round bar, and in any case individually made in an integral body piece.

In detail, each extension 7, 8 includes an upper main branch 11, 13 and a lower main branch 12, 14 arranged below the upper one.

More precisely, and preferably, the upper branches 11, 13 are symmetric to one another with respect to said vertical plane and so are the lower ones.

Each main branch 11, 12, 13, 14 includes a first front section 15, 16, 17, 18 originating from said tube 4 and extends at the rear, diverging from the above longitudinal axis A, as far as a respective fold 19, 20, 21, 22 (in this respect see the FIG. 2).

From such folds 19, 20, 21, 22, the relative main branch 11, 12, 13, 14 continues in a second intermediate section 23, 24, 25, 26, which extends substantially parallel to the longitudinal axis A, towards the rear of the motorcycle 1.

To be precise, the second sections 23, 24, 25, 26 are, in each extension 7, 8, substantially superimposed on one another, when the motorcycle is stood up.

The main branches 11, 12, 13, 14, in each extension 7, 8, lie on respective side planes, parallel to the longitudinal axis A and are joined by secondary branches, each of which is e.g. a round bar, made in an integral body piece, arranged in a relative side plane, to define the truss-like configuration.

In practice, between the two extensions 7, 8 there is a free internal space, apart from a short crosspiece 27, optionally provided between the two first lower sections 16, 18.

This free space, during use, houses the above casing 2, contained at the side and front by the extensions 7, 8 and by the tube.

In detail, the casing is preferably fitted on said second sections 23, 24, 25, 26, e.g., by means of bolts or other releasable locking means, at the respective coupling points 39, 40.

Furthermore, each of the extensions 7, 8 comprises an end part 28, 29, which terminates in a respective extremity 9, 10, to which a rear fork 30 is hinged oscillating, at coupling points 45.

The fork 30 is naturally coupled to the hub of the rear wheel 32.

Each end part 28, 29 can have a quadrilateral shape.

About the fork 30 and the suspension assembly of which it is part, more details will be provided later on.

The invention envisages a propulsion unit 31, fitted on the frame 3, which comprises an electric motor and a motorcycle transmission coupled to the electric motor, and connected to the rear wheel 32 by means of a chain, a belt or like flexible and inextensible transmission means.

More in detail, the propulsion unit 31 is fitted vertically, by means of releasable locking means, within the above free space, preferably arranged between said end parts 28, 29.

In particular, preferably, most of the propulsion unit 31 is positioned in front of the aforementioned extremities of the side extensions 7, 8, at the relative coupling points 41, 42, 43.

This does not mean it cannot be repositioned at a different point along the longitudinal extension of the frame 3.

Furthermore, the propulsion unit 31 is positioned behind the casing 2 of the battery (see for example FIG. 1).

The propulsion unit 31 has a protection and containment guard 33, which includes the electric motor and the transmission.

The propulsion unit 31 is part of a drive assembly which also includes a control unit 34 which drives the electric motor.

The control unit 34 is connected to the battery, by means of power cables and holes purposely provided in the casing 2, and is also connected to the electric motor, by means of further cables 35 which cross the guard 33.

The control unit 34 comprises an inverter 36 and, preferably, an electronic device 37 for controlling the inverter 36 (see the FIG. 3).

The device 37 is fitted on the inverter 36, integral with it, and is connected to the controls of the motorcycle 1 arranged on the handlebars 44.

In practice, the drive assembly is composed of two operating units 31, 34, connected together by the cables 35, and can be deemed as all one piece.

According to a major solution of the invention, the control unit 34 is fitted over the casing 2 of the battery, as shown in the FIG. 1.

This solution is made possible thanks to the fact that the batteries have the casing 2, which is able to support the control unit 34 and has a prismatic shape which allows coupling the unit 34 to one of its upper faces.

Before illustrating further structural aspects of the invention, the advantages of the configuration of the motorcycle 1 described thus far will be indicated below.

First of all, the invention envisages three fundamental functional units, each of which can be deemed as all one piece: the frame 3, which is a single body piece, the casing 2, which carries the battery, and the drive assembly 31, 34.

Consequently, unlike the prior art, the fitting and removal of the three fundamental units 2, 3, 31, 34 to and from one another is much easier and faster.

Furthermore, although the three fundamental units 2, 3, 31, 34 all appertain to the operation of the proposed motorcycle 1, they are not a functional restraint to one another.

In fact, unlike in prior art, in the event of the need arising, e.g., to change the battery with another one of different size, and therefore to have a wider or narrower casing 2, it is enough to move the propulsion unit 31 to an extent that takes into account the difference in overall dimensions of the casing 2, without having to make substantial changes to the frame 3.

Instead, in the prior art motorcycle, the electric motor represents a side of the cage frame, and consequently if this were moved, the frame would have to be redesigned, as would the suspension assembly, which is directly supported by such electric motor, while in the case of the invention this would not be necessary.

If therefore, with the progress of technology, the drive assembly 31, 34 or the batteries undergo a change in configuration, they can be replaced individually without having to redesign the rest of the motorcycle 1.

Furthermore, the above-mentioned solution of fitting the control unit 37 above the casing 2 results in the following two major advantages.

First of all, the inverter 36, the control device 37 and the cables 35 are far away from the road and from the wheels 6, 32 of the motorcycle 1.

Consequently, they are not affected by the rainwater or by the mud typically splashed by the wheels 6, 32, during the movement of the motorcycle 1.

It must be remembered that, although not shown in the attached illustrations, the motorcycle 1 of the invention comprises a casing that completely covers the control unit 34 and protects it from the rain.

Furthermore, the above solution permits positioning the battery casing 2 low enough to keep the centre of gravity of the motorcycle 1 close to the ground, without however risking any damage when this has to cross artificial bumps or the like.

It should be realised in fact that the battery is the heaviest component of the motorcycle 1 and its positioning in lowered position increases the rideability of the motorcycle 1 taking into account the fact that, as is known, the lowering of the centre of gravity of the motorcycle makes it easier for the rider to ride the vehicle.

Furthermore, the casing 2 is advantageously arranged between the controls of the handlebars 44 and the electric motor and consequently the length of the cables 35 is advantageously very reduced, as are the relative overall dimensions.

In detail, the cables connecting the control unit 34 and the motor to those connecting the battery and the control unit 34 are very short, and consequently they oppose an extremely small electric resistance to the transit of current, which in this case has very high values.

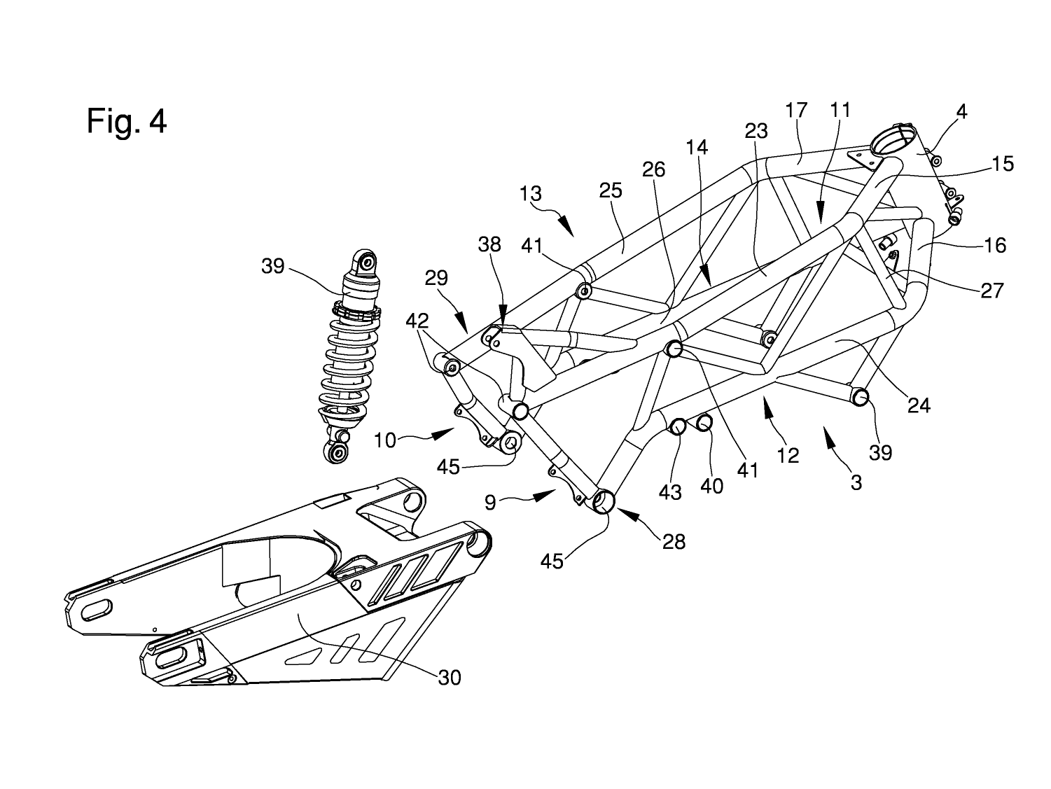

As, in part, already said above, the motorcycle 1 of the invention also comprises a shock-absorbing unit 30, 38, 39, shown in detail in FIG. 4.

Such unit first of all comprises the already-described fork 30, which can be of the double-arm type as in the solution shown in the illustrations or of the single-arm type; within the scope of the present invention in fact, by the term “fork” shall be meant any unit with one or more arms which supports the rear wheel 32.

The fork 30 is preferably arranged substantially behind the frame 3, being hinged to it at the two extremities 9, 10 with which the above-mentioned end parts 28, 29 of the frame 3 itself terminate.

The hinging axis of the fork 30 is substantially horizontal and at right angles to the vertical lying plane of the electric motorcycle 1.

The shock-absorbing unit 30, 38, 39 also includes a coupling bracket 38 fastened above one of such end parts 28, 29 (e.g., the right end part 28).

A further component of this unit is a shock-absorber 39 rotoidally coupled to the bracket 38, at its upper extremity, and to the fork 30, at the other extremity.

In detail, the rotoidal coupling between the shock-absorber 39 and the fork 30 can be arranged at or in the proximity of a side edge of the fork 30 itself.

It has in practice been ascertained how the described invention achieves the proposed objects making available a cheaper and more efficient electric motorcycle 1 than those of the prior art.

1) Electric motorcycle (1) comprising:
at least an electric battery;
at least a bearing frame (3) comprising a headtube (4) for the steering of at least a front wheel (6), from which headtube (4) extend laterally, in a single body piece, two truss-like extensions (7, 8) which elongate rearwardly, so as to substantially define a U-profile, said frame (3) being able to house said battery between said extensions (7, 8);
at least a propulsion unit (31), comprising an electric motor and a motorcycle transmission, the latter being coupled to said electric motor, said unit (31) being mounted on said frame (3); and
at least a rear fork (30) joined to a rear wheel (32) and mounted oscillating on said frame (3).

2) Motorcycle (1) according to claim 1, in which said motorcycle (1) comprises a control unit (34), connected to said battery and to said electric motor and comprising an inverter (36) mounted in said motorcycle (1) above said battery.

3) Motorcycle (1) according to claim 2, in which said control unit (34) comprises a device (37) for controlling said inverter (36).

4) Motorcycle (1) according to claim 3, in which said device (37) is arranged on top of said inverter (36).

5) Motorcycle (1) according to claim 2, in which said motorcycle (1) comprises a casing (2) which contains said battery, mounted within said frame (3), on top of which said inverter (36) is mounted.

6) Motorcycle (1) according to claim 1, in which said frame (3) is substantially symmetric with respect to a plane that passes through a longitudinal axis (A) of said motorcycle (1).

7) Motorcycle (1) according to claim 6, in which each of said extensions (7, 8) comprises at least two main branches (11, 12, 13, 14) individually made in an integral body piece, each having a first front section (15, 16, 17, 18) originating from said tube (4) and extends rearwardly, diverging from the longitudinal axis (A) of said motorcycle (1), as far as a respective bend (19, 20, 21, 22) from which said branch continues in a second section (23, 24, 25, 26) which extends substantially parallel to the longitudinal axis (A) of said motorcycle (1).

8) Motorcycle (1) according to claim 7, in which said electric battery is mounted on said second sections (23, 24, 25, 26).

9) Motorcycle (1) according to claim 1, in which said extensions (7, 8) comprise respective end parts (28, 29) to which said fork (30) is hinged.

10) Motorcycle (1) according to claim 9, in which said motorcycle (1) comprises a coupling bracket (38) and a shock-absorber (39), said coupling bracket (38) being fastened to the end part (28) of one of said extensions (7, 8), and said shock-absorber (39) being rotoidally coupled to said bracket (38) at one end and to said fork (30) at the other end.
